(19) United States
(12) Patent Application Publication
(10) Pub. No.: US 2026/0186961 A1
(43) Pub. Date: Jul. 2, 2026

(54) PARALLEL GARBAGE COLLECTION FROM MULTIPLE SNAPSHOT STORAGE INSTANCES

(71) Applicant: Nutanix, Inc., San Jose, CA (US)

(72) Inventors: Angshuman Bezbaruah, Redmond, WA (US); Brajesh Kumar Shrivastava, Milpitas, CA (US); Karan Gupta, San Jose, CA (US); Manosiz Bhattacharyya, San Jose, CA (US)

(21) Appl. No.: 19/005,446

(22) Filed: Dec. 30, 2024

(51) Int. Cl. G06F 12/02; G06F 16/11

(52) U.S. Cl. CPC G06F 12/0253; G06F 16/113; G06F 16/128

(57) ABSTRACT

A technique synchronizes garbage collection (e.g., lifecycle management) of point-in-time images or snapshots among multiple multi-cloud snapshot technology (MST) services of an archival storage system. Instances of the MST services are configured to provide storage and retrieval of large numbers (amounts) of snapshots (e.g., of recovery points) of application workloads stored on one or more shared buckets of an object store. The technique described herein allows performance of garbage collection operations on the snapshots in parallel among the multiple MST instances without communication or interference among the instances and in a manner that ensures correctness of the operations.

### BACKGROUND

### Technical Field

The present disclosure relates to archival of data and, more specifically, to efficient garbage collection of expired snapshots in an archival storage system.

### Background Information

File systems are primarily configured to process (i.e., store and retrieve) active input/output (I/O) data streams and are not generally configured to maintain large quantities of snapshots because they are primarily designed for rapid data changes (e.g., as “live” data) to support immediate access requests. Moreover, file systems generally process snapshot data indexing/location information together with storage layout and data storage to facilitate those immediate access requests. However, an archival storage system (e.g., an object store) is configured to maintain large quantities of snapshots for long-term storage and retention across numerous storage objects with infrequent data access requests. Accordingly, management of consumed storage of such archival storage systems is essential to reducing a storage footprint of their object stores as any of these snapshots may expire at any time, thus necessitating an efficient culling of storage across the numerous storage objects.

Object stores provided by public clouds and cloud service providers (CSPs) are ubiquitous and may be accessed (shared) from anywhere in the world. As such, management of the archived snapshots that are stored and retrieved from the object stores typically involves multiple storage services (running in different parts of the world) accessing a same set of snapshots stored on the same (shared) object store which can lead to data corruption since each instance of the service may presume control over snapshot data/metadata. Such shared access to snapshots is particularly problematic when performing parallel garbage collections from multiple storage services.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a block diagram of a controller virtual machine of the virtualization architecture;

FIG. 4 is a block diagram of metadata structures used to map virtual disks (vdisks) of the virtualization architecture;

FIGS. 5A-5C are block diagrams of an exemplary mechanism used to create a snapshot of a vdisk;

FIG. 6 is a block diagram of an exemplary data replication environment configured to replicate snapshots for storage to a multi-cloud snapshot technology (MST) of an archival storage system;

FIG. 7 is a block diagram of the MST of the archival storage system;

FIG. 8 is a block diagram illustrating an index data structure configured for efficient retrieval and garbage collection of snapshots of data from the MST;

FIG. 9 is a flow chart of a procedure for performing garbage collection (GC) for data in the MST of the archival storage system;

FIG. 10 is a block diagram of an embodiment of a MST instance of the archival storage system;

FIG. 11 is a block diagram of exemplary parent-child information maintained by a snapshot in a multi-instance MST (MMST) deployment;

FIG. 12 is a block diagram illustrating update of the parent-child information maintained by a snapshot in a MMST deployment;

FIG. 13 is a block diagram illustrating a MMST deployment wherein two MST instances create snapshots of recovery points;

FIG. 14 is a block diagram illustrating GC on a snapshot chain within an MST instance of a MMST deployment;

FIGS. 15A and 15B are flow charts of an extension to the GC procedure for garbage collecting data in a MMST deployment;

FIG. 16 is a block diagram illustrating exemplary MMST deployments for GC on a snapshot chain among MST instances; and

FIG. 17 is a block diagram illustrating other exemplary MMST deployments for GC on a snapshot chain among MST instances.

### OVERVIEW

The embodiments described herein are directed to a technique for synchronizing garbage collection (e.g., lifecycle management) of point-in-time images or snapshots among multiple long-term storage services of an archival storage system. Instances of the long-term storage services are configured to provide storage and retrieval of large numbers (amounts) of snapshots (e.g., of recovery points) of application workloads stored on one or more shared buckets of an object store. The technique described herein allows performance of garbage collection operations on the snapshots in parallel among the multiple long-term storage service instances without communication or interference among the instances (i.e., without a specific locking or synchronization protocol) and in a manner that ensures correctness of the operations.

In an embodiment, the long-term storage service instances may be embodied as multi-cloud snapshot technology (MST) instances configured to execute on one or more computer nodes to serve snapshots of recovery points (RPs) stored on the object store. Garbage collection (GC) of the snapshots involves managing index data structures (B+ trees) configured to provide efficient retrieval of data from large numbers of data objects. As used herein, a “data object” is an object (e.g., an Amazon S3 object, Azure Blob and the like) that contains data blocks (disk data) of one or more snapshots (e.g., disks). Notably, the data object may be shared between one or more snapshots, which presents an issue for GC because such indexing data structures reference data blocks that are shared across snapshots for storage efficiency.

The technique described herein extends a GC algorithm (e.g., procedure) to determine which data objects of data storage units (snapshots) exclusively own data blocks of expired snapshots by, e.g., scanning indexes of immediate parent and child snapshots to ascertain whether the snapshot is a candidate for GC (i.e., can be safely deleted by garbage collection). In accordance with the GC procedural extension, an MST instance can GC only those snapshots that it creates and owns. An MST owner instance is responsible for managing the lifecycles of those snapshots. An MST instance may start GC on a snapshot only if (i) there is no conflicting operation being performed on the snapshot, and (ii) there is no child snapshot owned by another MST instance. The GC procedural extension also determines which data objects can be reclaimed when a snapshot expires.

In an embodiment, data may be shared across multiple MST instances by holding a reference on a disk (e.g., snapshot) created by another MST instance as used in delta replication (e.g., incremental snapshot replication). A parent-child snapshot relationship may thus be created by choosing a reference candidate for delta replication. However, the reference candidate may be a parent snapshot owned by an MST instance that is different from the MST instance creating the child snapshot relationship. Each MST instance performs GC by comparing a set of objects (data and index objects) referred to by a snapshot with those objects being its parent and immediate children (e.g., using a pointer to the parent). The technique enhances a snapshot creation workflow by providing a child vector of a snapshot.

In an embodiment, each snapshot maintains information such as (i) the child vector including a list of one or more child snapshot identifiers and associated MST owner instance identifiers <child snapshot ID, owner MST ID> and (ii) a current parent reference in a child snapshot. This information is part of the snapshot metadata stored in the object store. When attempting GC on a (parent) snapshot, an MST instance inspects the child vector to determine if any of its child snapshots is owned by a different MST instance. If so, the MST instance defers the GC of the parent snapshot because a parent snapshot cannot be garbage collected if a child snapshot is owned by a different MST instance as data blocks may be shared between them. The different MST instance needs to first perform GC of the child snapshot and the child vector in the parent snapshot needs updating before GC of the parent snapshot may proceed.

### DESCRIPTION

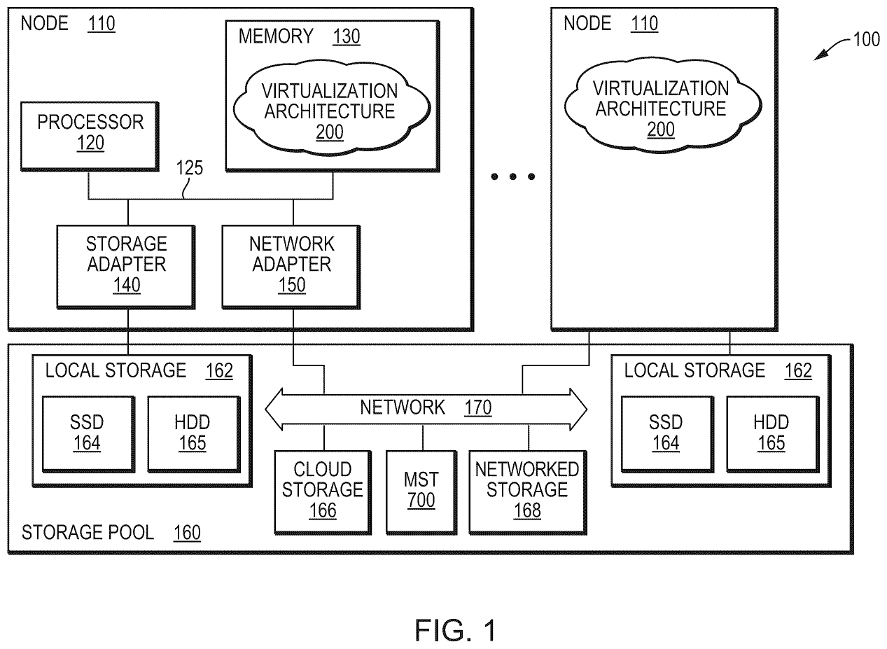

FIG. 1 is a block diagram of a plurality of nodes 110 interconnected as a cluster 100 and configured to provide compute and storage services for information, i.e., data and metadata, stored on storage devices of a virtualization environment. Each node 110 is illustratively embodied as a physical computer having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster-wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over network 170, which is illustratively an Ethernet local area network (LAN). The network adapter 150 may thus be embodied as a network interface card having the mechanical, electrical and signaling circuitry needed to connect the node 110 to the network 170. The multiple tiers of SOCS include storage that is accessible through the network 170, such as cloud storage 166 and/or networked storage 168, as well as the local storage 162 within or directly attached to the node 110 and managed as part of the storage pool 160 of storage objects, such as files and/or logical units (LUNs). The cloud and/or networked storage may be embodied as network attached storage (NAS) or storage area network (SAN) and include combinations of storage devices (e.g., SSDs and/or HDDs) from the storage pool 160. As described herein, a multi-cloud snapshot technology (MST) service (MST 700) of an archival storage system provides storage of large numbers (amounts) of point-in-time images or recovery points (i.e., snapshots) of application workloads on an object store. Communication over the network 170 may be affected by exchanging discrete frames or packets of data according to protocols, such as the Transmission Control Protocol/Internet Protocol (TCP/IP) and the OpenID Connect (OIDC) protocol, although other protocols, such as the User Datagram Protocol (UDP) and the HyperText Transfer Protocol Secure (HTTPS), as well as specialized application program interfaces (APIs) may also be advantageously employed.

The main memory 120 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes and programs being embodied as logic, components, and/or modules consisting of hardware, software, firmware, or combinations thereof.

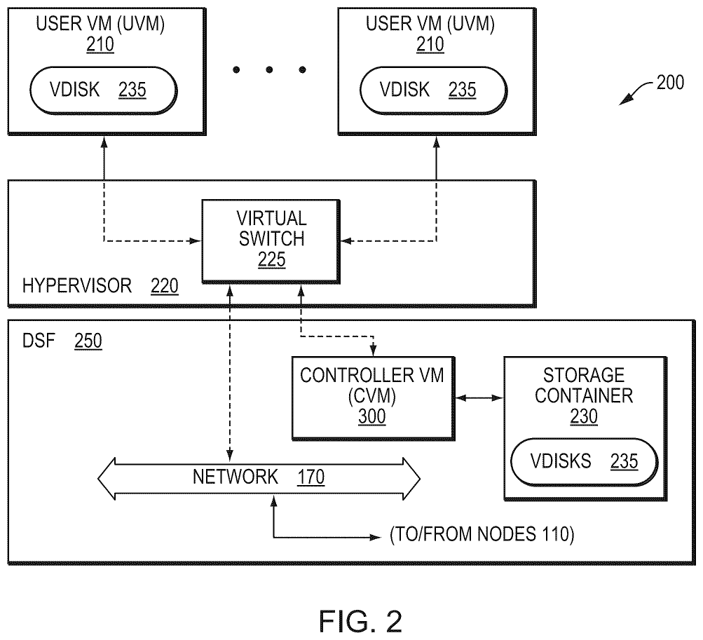

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 300, which functions as a virtual controller for SOCS. The CVMs 300 on the nodes 110 of the cluster 100 interact and cooperate to form a distributed system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyperconvergence architecture wherein the nodes provide both storage and computational resources available cluster wide.

The client software (e.g., applications) running in the UVMs 210 may access the DSF 250 using filesystem protocols, such as the network file system (NFS) protocol, the common internet file system (CIFS) protocol and the internet small computer system interface (ISCSI) protocol. Operations on these filesystem protocols are interposed at the hypervisor 220 and redirected (via virtual switch 225) to the CVM 300, which exports one or more iSCSI, CIFS, or NFS targets organized from the storage objects in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 300 on the same or different node 110. The UVM 210 may issue the I/O accesses as a SCSI protocol request to the storage device. Illustratively, the hypervisor 220 intercepts the SCSI request and converts it to an ISCSI, CIFS, or NFS request as part of its hardware emulation layer. As previously noted, a virtual SCSI disk attached to the UVM 210 may be embodied as either an ISCSI LUN or a file served by an NES or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 300 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 300 within the same node as the UVM 210, then the IP-based storage protocol request is internally forwarded within the node to the CVM. The CVM 300 is configured and structured to properly interpret and process that request. Notably, the IP-based storage protocol request packets may remain in the node 110 when the communication—the request and the response—begins and ends within the hypervisor 220. In other embodiments, the IP-based storage protocol request may be routed by the virtual switch 225 to a CVM 300 on another node of the cluster 100 for processing. Specifically, the IP-based storage protocol request is forwarded by the virtual switch 225 to a physical switch (not shown) for transmission over network 170 to the other node. The virtual switch 225 within the hypervisor 220 on the other node then forwards the request to the CVM 300 on that node for further processing.

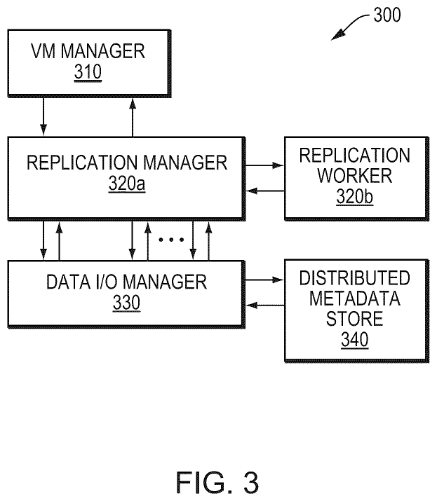

FIG. 3 is a block diagram of the controller virtual machine (CVM) 300 of the virtualization architecture 200. In one or more embodiments, the CVM 300 runs an operating system (e.g., the Acropolis operating system) that is a variant of the Linux® operating system, although other operating systems may also be used in accordance with the embodiments described herein. The CVM 300 functions as a distributed storage controller to manage storage and I/O activities within DSF 250 of the cluster 100. Illustratively, the CVM 300 runs as a virtual machine above the hypervisor 220 on each node and cooperates with other CVMs in the cluster to form the distributed system that manages the storage resources of the cluster, including the local storage 162, the networked storage 168, and the cloud storage 166. Since the CVMs run as virtual machines above the hypervisors and, thus, can be used in conjunction with any hypervisor from any virtualization vendor, the virtualization architecture 200 can be used and implemented within any virtual machine architecture, allowing the CVM to be hypervisor agnostic. The CVM 300 may therefore be used in a variety of different operating environments due to the broad interoperability of the industry standard IP-based storage protocols (e.g., iSCSI, CIFS, and NFS) supported by the CVM.

Illustratively, the CVM 300 includes a plurality of processes embodied as a storage stack running in a user space of the operating system of the CVM to provide storage and I/O management services within DSF 250. The processes include a virtual machine (VM) manager 310 configured to manage creation, deletion, addition and removal of virtual machines (such as UVMs 210) on a node 110 of the cluster 100. For example, if a UVM fails or crashes, the VM manager 310 may spawn another UVM 210 on the node. A replication manager 320a is configured to provide replication and disaster recovery capabilities of DSF 250. Such capabilities include migration/failover of virtual machines and containers, as well as scheduling of snapshots. In an embodiment, the replication manager 320a may interact with one or more replication workers 320b. A data I/O manager 330 is responsible for all data management and I/O operations in DSF 250 and provides a main interface to/from the hypervisor 220, e.g., via the IP-based storage protocols. Illustratively, the data I/O manager 330 presents a vdisk 235 to the UVM 210 in order to service I/O access requests by the UVM to the DFS. A distributed metadata store 340 stores and manages all metadata in the node/cluster, including metadata structures that store metadata used to locate (map) the actual content of vdisks on the storage devices of the cluster.

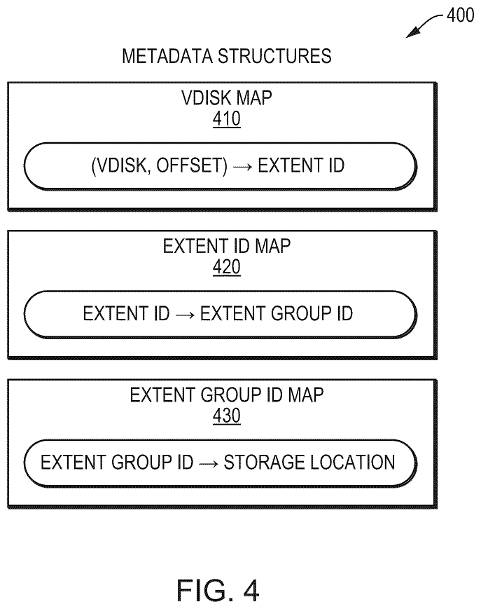

FIG. 4 is a block diagram of metadata structures 400 used to map virtual disks of the virtualization architecture. Each vdisk 235 corresponds to a virtual address space for storage exposed as a disk to the UVMs 210. Illustratively, the address space is divided into equal sized units called virtual blocks (vblocks). A vblock is a chunk of pre-determined storage, e.g., 1 MB, corresponding to a virtual address space of the vdisk that is used as the basis of metadata block map structures described herein. The data in each vblock is physically stored on a storage device in units called extents. Extents may be written/read/modified on a sub-extent basis (called a slice) for granularity and efficiency. A plurality of extents may be grouped together in a unit called an extent group. Bach extent and extent group may be assigned a unique identifier (ID), referred to as an extent ID and extent group ID, respectively. An extent group is a unit of physical allocation that is stored as a file on the storage devices.

Illustratively, a first metadata structure embodied as a vdisk map 410 is used to logically map the vdisk address space for stored extents. Given a specified vdisk and offset, the logical vdisk map 410 may be used to identify a corresponding extent (represented by extent ID). A second metadata structure embodied as an extent ID map 420 is used to logically map an extent to an extent group. Given a specified extent ID, the logical extent ID map 420 may be used to identify a corresponding extent group containing the extent. A third metadata structure embodied as an extent group ID map 430 is used to map a specific physical storage location for the extent group. Given a specified extent group ID, the physical extent group ID map 430 may be used to identify information corresponding to the physical location of the extent group on the storage devices such as, for example, (1) an identifier of a storage device that stores the extent group, (2) a list of extent IDs corresponding to extents in that extent group, and (3) information about the extents, such as reference counts, checksums, and offset locations.

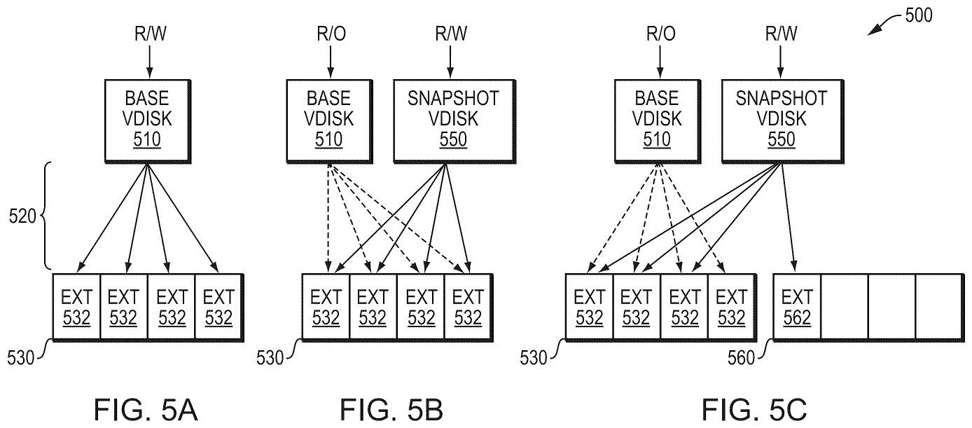

In an embodiment, CVM 300 and DSF 250 cooperate to provide support for snapshots, which are point-in-time copies of storage objects, such as files, LUNs and/or vdisks. FIGS. 5A-5C are block diagrams of an exemplary mechanism 500 used to create a snapshot of a virtual disk. Illustratively, the snapshot may be created by leveraging an efficient low overhead snapshot mechanism, such as the redirect-on-write algorithm. As shown in FIG. 5A, the vdisk (base vdisk 510) is originally marked read/write (R/W) and has an associated block map 520, i.e., a metadata mapping with pointers that reference (point to) the extents 532 of an extent group 530 storing data of the vdisk on storage devices of DSF 250. Advantageously, associating a block map with a vdisk obviates traversal of a snapshot chain, as well as corresponding overhead (e.g., read latency) and performance impact.

To create the snapshot (FIG. 5B), another vdisk (snapshot vdisk 550) is created by sharing the block map 520 with the base vdisk 510. This feature of the low overhead snapshot mechanism enables creation of the snapshot vdisk 550 without the need to immediately copy the contents of the base vdisk 510. Notably, the snapshot mechanism uses redirect-on-write such that, from the UVM perspective, I/O accesses to the vdisk are redirected to the snapshot vdisk 550 which now becomes the (live) vdisk and the base vdisk 510 becomes the point-in-time copy, i.e., an “immutable snapshot,” of the vdisk data. The base vdisk 510 is then marked immutable, e.g., read-only (R/O), and the snapshot vdisk 550 is marked as mutable, e.g., read/write (R/W), to accommodate new writes and copying of data from the base vdisk to the snapshot vdisk. In an embodiment, the contents of the snapshot vdisk 550 may be populated at a later time using, e.g., a lazy copy procedure in which the contents of the base vdisk 510 are copied to the snapshot vdisk 550 over time. The lazy copy procedure may configure DSF 250 to wait until a period of light resource usage or activity to perform copying of existing data in the base vdisk. Note that each vdisk includes its own metadata structures 400 used to identify and locate extents owned by the vdisk.

Another procedure that may be employed to populate the snapshot vdisk 550 waits until there is a request to write (i.e., modify) data in the snapshot vdisk 550. Depending upon the type of requested write operation performed on the data, there may or may not be a need to perform copying of the existing data from the base vdisk 510 to the snapshot vdisk. 550. For example, the requested write operation may completely or substantially overwrite the contents of a vblock in the snapshot vdisk 550 with new data. Since the existing data of the corresponding vblock in the base vdisk 510 will be overwritten, no copying of that existing data is needed and the new data may be written to the snapshot vdisk at an unoccupied location on the DSF storage (FIG. 5C). Here, the block map 520 of the snapshot vdisk 550 directly references a new extent 562 of a new extent group 560 storing the new data on storage devices of DSF 250. However, if the requested write operation only overwrites a small portion of the existing data in the base vdisk 510, the contents of the corresponding vblock in the base vdisk may be copied to the snapshot vdisk 550 and the new data of the write operation may be written to the snapshot vdisk to modify that portion of the copied vblock. A combination of these procedures may be employed to populate the data content of the snapshot vdisk.

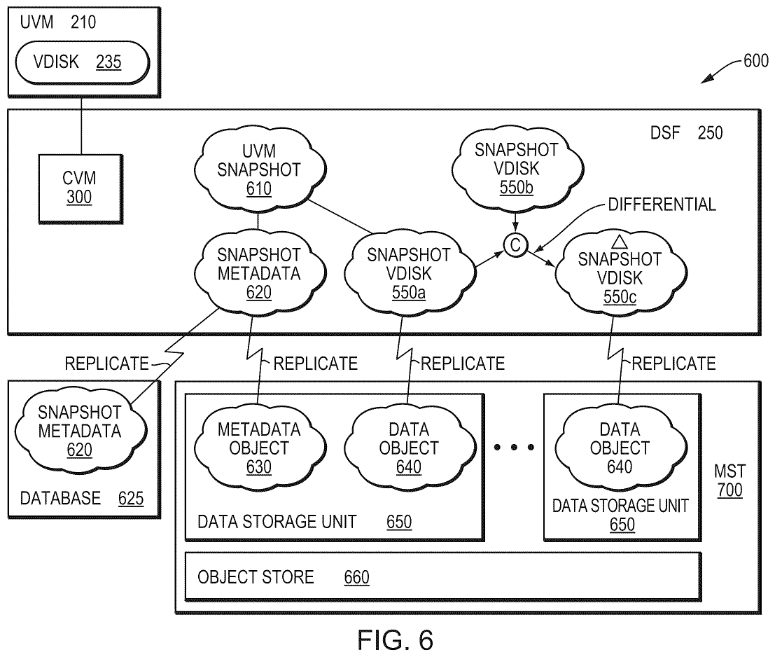

FIG. 6 is a block diagram of an exemplary data replication environment 600 configured to replicate snapshots for storage to the MST of the archival storage system. The architecture of MST 700 is configured to process large amounts of point-in-time images or recovery points (i.e., snapshots) of application workloads for storage on an object store 660 (archival storage vendor such as Amazon AWS S3 storage services, Google Cloud Storage, Microsoft Azure Cloud Storage and the like), wherein the workloads are characterized by a logical entity having typed data, e.g., a virtual machine (VM) such as a UVM 210. A client of MST 700 may be a distributed file system of a storage system (e.g., CVM 300 of DSF 250) that generates snapshots of the UVM (e.g., data processed by an application running in the UVM) and replicates the UVM snapshot 610 for storage in the object store 660. Replication, in this context, is directed to storage devices that exhibit incremental, block-level changes. MST 700 is thus a “generic” long-term storage service of an archival/backup storage system from the perspective of the client, i.e., the client flushes (delivers) data blocks of UVM snapshots 610 to the MST 700, which organizes the blocks for long-term storage in the object store 660. Each UVM snapshot 610 is generally handled as a data storage unit 650 by MST 700.

Illustratively, the content of each UVM snapshot 610 includes snapshot metadata and snapshot data, wherein the snapshot metadata 620 is essentially configuration information describing the logical entity (e.g., UVM 210) in terms of, e.g., virtual processor, memory, network and storage device resources of the UVM. The snapshot metadata 620 of the UVM 210 is illustratively replicated for storage in a query-able database 625 although, in an embodiment, the snapshot metadata 620 may be further replicated and organized as a metadata object 630 within a configuration namespace (e.g., bucket) of the object store 660 of MST 700 for long-term durability and availability. The data of the UVM 210 is virtualized as a disk (e.g., vdisk 235) and, upon generation of a snapshot, is processed as snapshot vdisk 550 of the UVM 210. The snapshot vdisk 550 is replicated, organized and arranged as one or more data objects 640 of the data storage unit 650 for storage in the object store 660. Each extent 532 of the snapshot vdisk 550 is a contiguous range of address space of a data object 640, wherein data blocks of the extents are “packed” into the data object 640 and accessible by, e.g., offsets and lengths. Note that a preferred size (e.g., 16 MB) of each data object 640 may be specified by the object store/vendor (e.g., AWS S3 cloud storage) for optimal use of the object store/vendor.

Operationally, the client initially generates a full snapshot of vdisk 235 (e.g., snapshot vdisk 550a) and transmits copies (i.e., replicas) of its data blocks to effectively replicate the snapshot vdisk 550a to MST 700. The snapshot vdisk 550a is thereafter used as a reference snapshot for comparison with one or more subsequent snapshots of the vdisk 235 (e.g., snapshot vdisk 550b) when computing incremental differences (deltas As). The client (e.g., CVM 300) generates the subsequent vdisk snapshots 550b at predetermined (periodic) time intervals and computes the deltas of these periodically generated snapshots with respect to the reference snapshot. The CVM 300 transmits replicas of data blocks of these deltas (delta replication) as A snapshot vdisk 550c to MST. From the perspective of the CVM 300, the MST 700 is a storage entity having an address on the network 170 (or WAN), similar to any networked storage 168. However, unlike networked storage 168, which is generally exposed to (accessed by) the CVM 300 using filesystem protocols such as NFS, CIFS and iSCSI, the MST 700 is accessed using specialized application program interfaces (APIs) referred to herein as replication APIs, which have rich descriptive semantics. For example, a replication API may specify the snapshotted vdisk 550a of the logical entity (e.g., UVM 210) as well as information describing the snapshot metadata 620 and snapshot vdisk 550a of the entity. The CVM 300 then transmits (replicates) a stream of data blocks of the snapshotted vdisk 550a to MST 700.

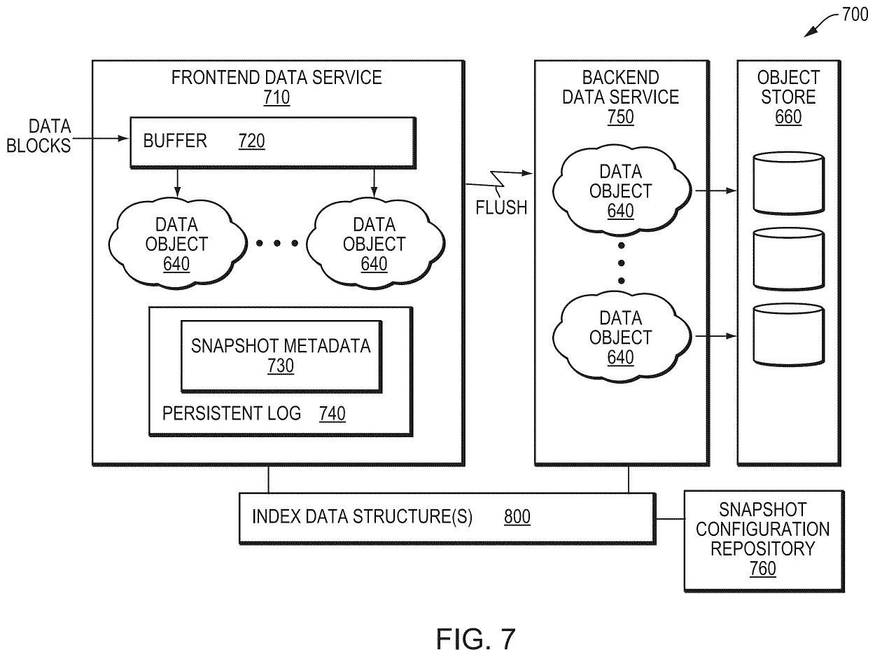

FIG. 7 is a block diagram of the MST 700 of the archival storage system. Illustratively, the MST 700 includes two data services (processes): a frontend data service 710 that cooperates with the client (e.g., CVM 300) to organize large amounts of the replicated snapshot data (data blocks) into data objects 640 and a backend data service 750 that provides an interface for storing the data objects 640 in the object store 660. In an embodiment, the MST data services/processes may execute on a computing platform at any location and is generally “stateless” as all data/metadata are stored on the object store 660. Accordingly, the frontend data service 710 and backend data service 750 may run either locally on a node of an “on-prem” cluster or remotely on a node of an “in-cloud” cluster. In response to receiving an initial replication API directed to the snapshot vdisk 550a, the frontend data service 710 temporarily stores the stream of data blocks of the snapshot vdisk 550a, e.g., in a buffer 720 and writes the data blocks into one or more extents (i.e., contiguous, non-overlapping, variable-length regions of the vdisk) for storage in data objects 640 of a preferred size (e.g., 16 MB) as specified by the object store vendor for optimal use. The frontend data service 710 then forwards (flushes) the data objects 640 to the backend data service 750 for storage in the object store 660 (e.g., AWS S3). In response to receiving a subsequent replication API directed to the A snapshot vdisk 550c, the frontend data service temporarily stores the stream of data blocks of the A snapshot vdisk 550c in buffer 720, writes those data blocks to one or more data objects 640, and flushes the objects to the backend data service 750.

Prior to flushing the data objects 640 to the backend data service 750, the frontend data service 710 creates metadata that keeps track of the amount of data blocks received from the CVM 300 for each replicated snapshot, e.g., snapshot vdisk 550a as well as A snapshot vdisk 550c. The metadata associated with the snapshot (i.e., snapshot metadata 730) is recorded as an entry in persistent storage media (e.g., a persistent log 740) local to the frontend data service 710. The snapshot metadata 730 includes information describing the snapshot data, e.g., a logical offset range of the snapshot vdisk 550. In an embodiment, the snapshot metadata 730 is stored as an entry of the persistent log 740 in a format such as, e.g., snapshot ID, logical offset range of snapshot data, logical offset into the data object to support storing multiple extents into a data object, and data object ID. The frontend data service 710 updates the snapshot metadata 730 of the log entry for each data object 640 flushed to the backend data service 750. Notably, the snapshot metadata 730 is used by the frontend data service 710 to construct the index data structure 800 of MST.

Illustratively, the index data structure 800 is configured to enable efficient identification (location) and retrieval of data blocks contained within numerous data objects 640 (snapshots) stored on the object store 660. Effectively, the index data structure acts as an independent database organized to retrieve data by extent of a vdisk (as recorded in the associated object store of the archival storage system) according to any snapshot. Notably, each snapshot is associated with a corresponding index data structure and may include incremental changes to a prior snapshot that may reference a prior index data structure associated with the prior snapshot. In this manner, only the incremental changes between snapshots need be stored in the archival storage system as indicated above, because later index data structures may reference (via prior index data structures) older blocks in prior snapshots.

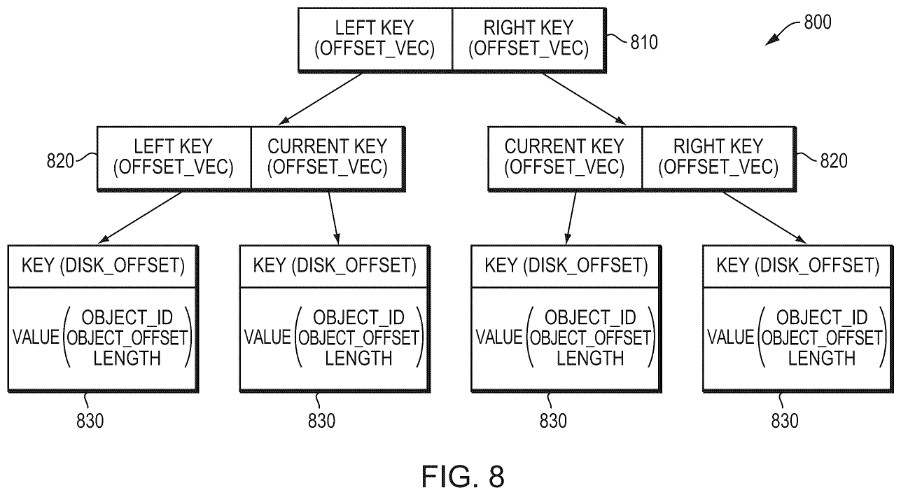

FIG. 8 is a block diagram illustrating the index data structure 800 configured for efficient retrieval and garbage collection of snapshots from the MST of the archival storage system. In one or more embodiments, the index data structure 800 is illustratively a balanced tree (e.g., a B+ tree) with a large branching factor for internal nodes to maintain a limited depth of the tree, although other types of data structures, such as heaps and hashes, may be used with the embodiments described herein. When embodied as the B+ tree, the index data structure includes a root node 810, one or more intermediate (internal) nodes 820 and a plurality of leaf nodes 830. For the reference snapshot vdisk 550a, each internal node 820 contains a set of keys that specify logical offset ranges into the address space of the vdisk 550a and corresponding values that reference other nodes in the B+ tree (e.g., lower level internal nodes or leaf nodes). Each leaf node 830 contains a value describing (pointing to) a data object having the extent that includes selected data blocks corresponding to a specified logical offset range as well as a logical offset of the extent in the data object and length of the extent. In other words, a leaf node can be considered as a 4-tuple having: (i) a logical offset in the address space of the logical entity (e.g., snapshot), (ii) a data object id, (iii) a logical offset of the extent into the data object, and (iv) a length of the extent. To find the leaf node 830 pointing to a selected data block of a particular snapshot (data object) only requires traversing the depth of an index data structure. Notably, a large branching factor (e.g., 1024) for internal nodes permits a very large number of references in the internal nodes 820 of the B+ tree so that a depth of the tree is reduced (e.g., to 2 or 3 levels) enabling an effective bounded traversal time from the root node to a leaf node (e.g., traverse at most 3 nodes to locate data in the object store). The address space covered by the leaf nodes is of variable length and depends upon a number of extents referenced according to the branching factor. In an embodiment, the internal nodes have a branching factor much larger than the leaf nodes to support a very large address space (e.g., given an extent size of less than 1 MB and a branching factor of 32K, a two-level B-tree can reference an address space as great as 16 exabytes).

In an embodiment, each internal node 820 contains keys and pointers to children nodes, and generally not any values. The root node 810 is a variant of the internal node 820 but, similar to the internal node, contains disk offsets as keys. For each key, a left pointer points to data of the vdisk ranging from a left key to (and including) a current key; illustratively, data in a “child” internal node 820 for the left pointer embodies the form [left key, current key]. A right pointer points to data of the vdisk ranging from the current key to (but excluding) a right key; illustratively, data in a child internal node for the right pointer embodies the form [current key, right key]. The fields of the internal node illustratively include (i) Offset_Vec containing a list of offsets in the vdisk that function as one or more keys; and (ii) Child_Pointer_Vec containing a pointer(s) to a child (ren) node(s). The leaf node 830 contains a predetermined number of descriptors (e.g., up to 1024), each of which describes the vdisk address space covered by the descriptor and the location of the corresponding data in the form of the following keys and values:
Key (Disk_Offset)->Value (Object_ID, Object_Logical_Offset, Length)
   wherein Disk_Offset refers to the offset within the vdisk; Object_ID identifies the data object in the archival storage system and may be a combination of a vdisk uuid and an assigned predefined (int64) number; Object_Logical_Offset is the logical offset with the object (specified by Object_ID) at which the data resides; and Length is the number of contiguous bytes (size of the extent) beginning at “Offset” (Disk_Offset) that is pointed to by the key entry.

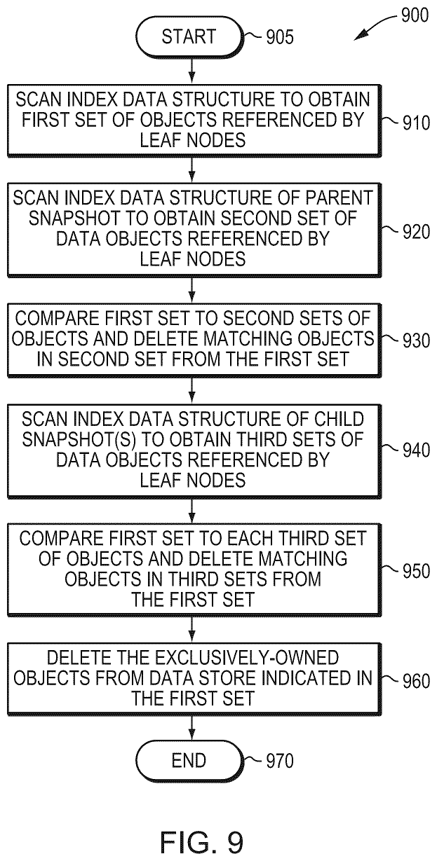

The embodiments described herein are related to a technique for improving storage efficiency of an object store configured to maintain numerous snapshots for long-term storage in an archival storage system by efficiently determining data that is exclusively owned by an expiring snapshot to allow deletion of the expiring snapshot from the object store of the archival storage system. To that end, the technique involves managing index data structures to enable efficient garbage collection (GC) across a very large number of data objects. FIG. 9 is a flow chart of a procedure for performing garbage collection (GC) for data in the MST of the archival storage system in accordance with the technique.

Assume a base (reference) snapshot vdisk 1 (e.g., vdisk 550a) is generated from vdisk 235 and is organized as data storage unit 1. Illustratively, the snapshot vdisk 1 is apportioned into a plurality of (“n”) data objects. If the snapshot vdisk 1 has an address space of 1 TB and each data object has a (logical) address space of 16 MB, then there are 1 TB/16 MB=“n” (i.e., 65,536) data objects associated with (and initially exclusively owned by) the data storage unit 1 (e.g., snapshot vdisk 1). Now assume snapshot vdisk 2 (e.g., vdisk 550b) is generated that has 1 GB of changed (4) data, e.g., at offset range of GB-6 GB of snapshot vdisk 1, such that there are 1 GB/16 MB=“m” (i.e., 62) data objects associated with (and initially exclusively owned by) the data storage unit 2 as A snapshot vdisk 2 (e.g., A snapshot vdisk 550c). Thus, for address space 0-5 GB and 6 GB-1 TB, A snapshot vdisk 2 inherits (i.e., references) the same “n-m” data objects as are present in snapshot vdisk 1 (snapshot 1).

Now, assume a snapshot has expired per a retention policy and a determination is rendered as to whether the snapshot can be deleted (i.e., garbage collected). The object store has numerous snapshots with various dependencies and inter-relationships. In an embodiment, the following steps of the GC procedure 900 are illustratively performed by the frontend data service 710 of MST 700, although it is known to persons of skill in the art that the procedure may be performed by other services. The GC procedure starts at 905 and proceeds to the following steps:
1. At step 910, scan the index data structure (tree) (e.g., index data structure 800) of the expiring snapshot from its root node to its leaf nodes to obtain a first set of object IDs associated with data objects referenced by the leaf nodes.
2. At step 920, scan the index data structure (tree) of the immediate predecessor (parent) snapshot from its root node to its leaf nodes to obtain a second set of object IDs associated with data objects referenced by the leaf nodes.
3. At step 930, compare the first and second sets of object IDs. The object IDs that match represent data objects that are inherited from the parent snapshot (i.e., reference data objects from the parent snapshot) and may not be deleted. The matching object IDs are removed from the first set of object IDs.
   a. The remaining object IDs from the first set represent data objects exclusive to (originated by) the expiring snapshot (i.e., are not inherited from the parent snapshot) and are candidates for GC. Note that these data objects are only candidates (not certain) for GC because an immediate successor (child) snapshot of the expiring snapshot may still inherit (reference) one or more of the data objects.
4. At step 940, scan the index data structure (tree) of the immediate successor (child) snapshot from its root node to its leaf nodes to obtain a third set of object IDs associated with data objects referenced by the leaf nodes.
   a. In an embodiment, there may be multiple children snapshots that are immediate successors to the expiring snapshot. For this embodiment, each index data structure (tree) for each child snapshot is separately scanned from its root node to its leaf nodes to obtain another (i.e., separate) third set of objects IDs associated with data objects referenced by the leaf nodes.
5. At step 950, compare the first set of objects IDs with each of the third set of object IDs. The object IDs that match represent data objects that are inherited from the expiring snapshot and, thus, may not be deleted. The matching object IDs are removed from the first set of object IDs.
   a. The remaining object IDs from the first set represent data objects exclusively owned by the expiring snapshot (i.e., are not inherited from the parent snapshot and are not inherited by the child snapshot and any subsequent snapshot) and thus may be GC′d. Note that if a child snapshot does not inherit a data object from the expiring snapshot, then any grandchild also cannot inherit that data object.
   b. Of the matching object IDs that are inherited from the expiring snapshot by the child snapshot, there may be a fractional (partial) sharing or overlapping of the associated data objects. Accordingly, the inherited data objects represented by these matching object IDs are candidates for compaction. As such, the technique determines whether the matching object IDs are overlapping.

In an embodiment, compaction may be affected by preserving (storing) the partially overlapping snapshot data of an inherited data object to another data object. For example, assume a child snapshot inherits a data object from an expiring snapshot that partially overlaps a 1 MB address space of snapshot data. The inherited data object may not be deleted until the overlapping snapshot data is re-written to another data object to remove the overlap by an operation that involves, e.g., reading the overlapping snapshot data of the candidate data object and writing the data to a new (or existing) data object. However, such an operation is costly in terms of processing and, as such, may be desirable only if it results in substantial storage space cost savings. That is, a cost tradeoff involves consideration of performing compaction (e.g., I/O access and computation) vs. cost savings from reduced storage consumption.

According to the technique, if the fractional overlap (i.e., utilization) of the inherited data object is above a predetermined threshold, then the data object is treated as any other inherited data object (as in Step 930) and is not deleted. In an embodiment, the predetermined threshold may be 15%, although other percentages of utilization may be similarly employed. However, if the utilization of the inherited data object is below the predetermined threshold, then the data object may be compacted. Illustratively, the overlapping snapshot data may be read and written to a new data object of the child snapshot, wherein the new data object has the same object ID as the inherited data object. The inherited data object of the expiring snapshot may then be deleted by, e.g., deleting the reference to the object in the leaf node of the expiring snapshot. Note that the threshold may be determined based on a cost model of compaction vs. storage savings according to the archival storage vendor services pricing (e.g., relatively high cost to write data, but low cost to retrieve and store data).

In an embodiment, an internal structure of a data object (not shown) is organized into one or more “slices” representing offset ranges of the logical address space of the data object. Each slice has a metadata header used to specify an offset range for valid snapshot data. Essentially, when performing compaction, the nodes of the index data structure (B+ tree) are not modified; only the metadata headers of data objects referenced by the (leaf) nodes are revised/updated (e.g., by the frontend data service of MST) to specify offset ranges of valid snapshot data. In this manner, only a small amount of information (i.e., the header information) is changed without affecting the references of the leaf nodes, which may involve a large number of snapshots for very old data. That is, invalid ranges (i.e., deleted by garbage collection) of snapshot data are removed from the metadata header without a need to change the index data structures.
6. At step 960, delete the exclusively owned data objects for the expiring snapshot represented by the object IDs remaining from the first set of object IDs (after steps 910 to 950).

The procedure ends at the following step 970.

As described herein, management of the snapshots that are stored and retrieved from an object store may be embodied as a long-term storage service, such as MST, that provides storage of large numbers (amounts) of snapshots on the object store. Typically, an MST service assumes exclusive control over snapshot-related metadata (including index data structures configured to provide efficient retrieval of data from the large number of snapshots) in the object store. However, multiple MST services (running in different parts of the world) accessing the same set of snapshots stored on the same (shared) object store can lead to data corruption since each instance of the service assumes total control over snapshot data/metadata. Such shared access to snapshots is particularly problematic when performing parallel garbage collections from multiple MST services.

The embodiments described herein are further related to a technique configured to allow instantiation (spinning up) and running (execution) of MST services of the archival storage system on demand and at various geographical locations (throughout the world). The instantiated MST instances are configured to provide storage and retrieval of large numbers (amounts) of point-in-time images or snapshots (e.g., recovery points) of application workloads stored as objects on one or more buckets of a shared object store. According to the technique, the MST instances may serve (access) snapshots of a same set of buckets on the shared object store without interfering (avoiding inconsistency) with each other. That is, the technique enables MST instances that are paired with (configured to access) snapshot workload data and/or metadata stored, e.g., as objects of a recovery point, on the same set of buckets to coexist without knowledge of (or need to communicate with) each other. The MST instances can be created and destroyed on-demand by splitting and merging the existing instances.

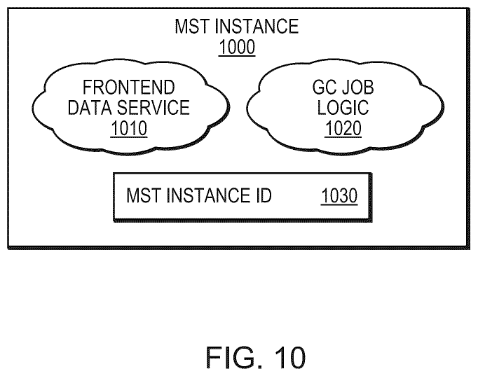

In an embodiment, the MST instances are configured to execute on one or more computer nodes to serve snapshots of recovery points (RPs) stored on the object store, which may be part of cloud storage 166. FIG. 10 is a block diagram of an embodiment of an MST instance 1000 of the archival storage system. Every MST instance 1000 has an identifier (ID) which is illustratively a universally unique ID (UUID). Each MST instance 1000 that creates a snapshot object (snapshot) also stamps (records) the snapshot with the MST instance ID 1030. An aspect of the technique is directed to a multi-instance MST (MMST) deployment that synchronizes operations of multiple MST instances through the object store 660 without knowledge of or communication (such as a distributed communication protocol) among the MST instances. Although snapshots can be accessed and read by any MST instance 1000 (since they are stored on shared buckets of a shared object store), the responsibility to manage a lifecycle (e.g., to perform garbage collection) of each snapshot lies with a respective MST owner instance, which allows scaling of garbage collection (GC) by distributing the overall GC load to various instances.

The embodiments described herein are directed to a technique for synchronizing garbage collection (e.g., lifecycle management) of point-in-time images or snapshots among multiple MST services of an archival storage system. Instances of the MST services are configured to provide storage and retrieval of large numbers (amounts) of snapshots (e.g., of recovery points) of application workloads stored on one or more shared buckets of an object store. The technique described herein allows performance of garbage collection (GC) operations on the snapshots in parallel among the multiple MST instances without communication or interference among the instances and in a manner that ensures correctness of the operations. Illustratively, GC of the snapshots involves managing index data structures (B+ trees) configured to provide efficient retrieval of data from a large number of data objects. As used herein, a “data object” is an object (e.g., an Amazon S3 object, Azure blob or the like) that contains data blocks (disk data) of one or more snapshots (e.g., disks). Notably, the data object may be shared between one or more snapshots, which presents an issue for GC because such indexing data structures reference many data blocks shared across snapshots for storage efficiency.

In an embodiment, data may be shared across multiple MST instances by holding a reference on a disk (e.g., snapshot) created by another MST instance 1000 as used in delta replication. A parent-child snapshot relationship may thus be created by choosing a reference candidate for delta replication. However, the reference candidate may be a parent snapshot owned by an MST instance 1000 that is different from the MST instance creating the child relationship. As described herein, each MST instance 1000 performs GC by comparing a set of objects (data and index objects) referred to by a snapshot with those objects being its parent and immediate children (e.g., using a pointer to the parent). The technique enhances a snapshot creation workflow by providing a child vector of a snapshot.

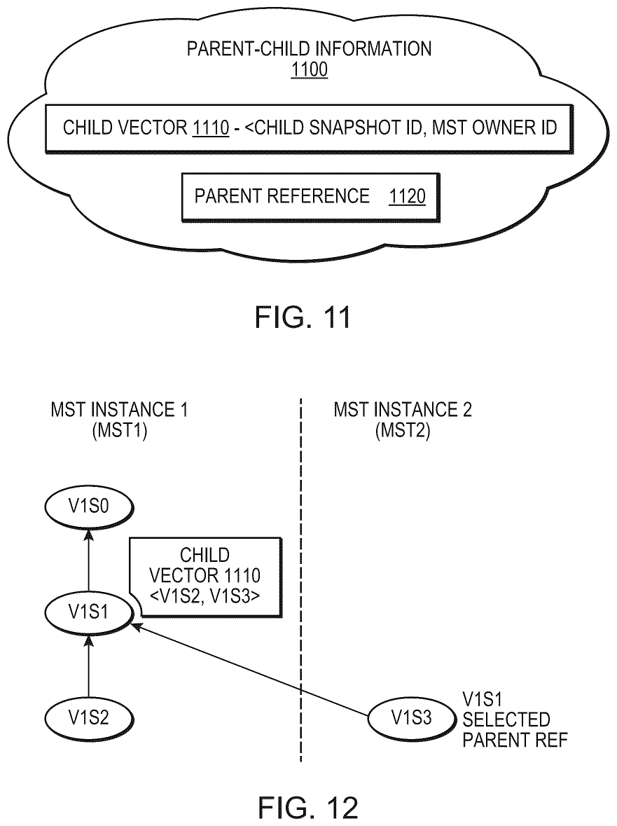

FIG. 11 is a block diagram of exemplary parent-child information maintained by a snapshot in a multi-instance MMST deployment. In an embodiment, each snapshot maintains parent-child information 1100 such as (i) the child vector field 1110 including a list of one or more child snapshot identifiers and associated MST owner instance identifiers <child snapshot ID, owner MST ID> and (ii) a parent reference field 1120 including a current parent snapshot referenced in a child snapshot. This information is illustratively part of the snapshot metadata, e.g., of snapshot (disk) configuration stored in the object store 660. When attempting GC on a (parent) snapshot, an MST instance 1000 inspects the child vector field 1110 to determine if any of its child snapshots is owned by a different MST instance. If so, the MST instance defers the GC of the parent snapshot because a parent snapshot cannot be garbage collected if a child snapshot is owned by a different MST instance as data blocks may be shared between them. The different MST instance needs to first perform GC of the child snapshot and the child vector in the parent snapshot needs updating before GC of the parent snapshot may proceed.

### Reference Resolution

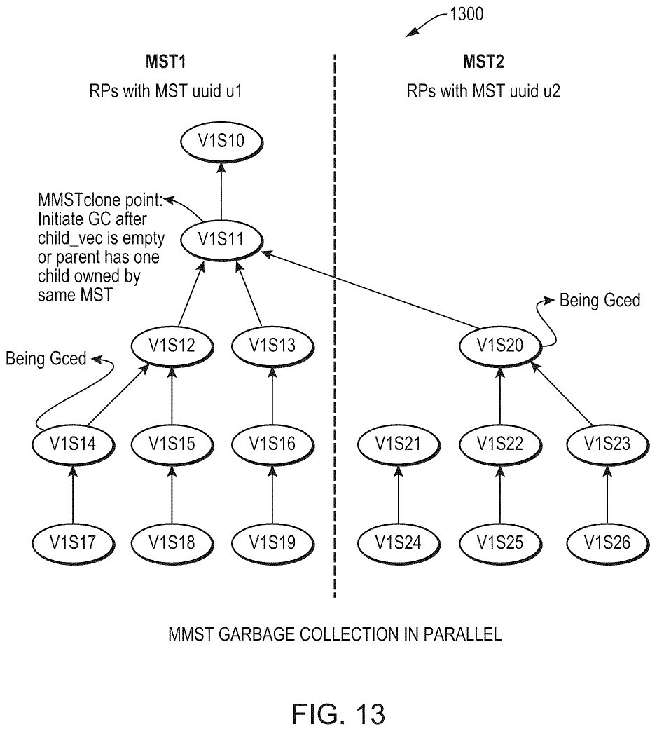

In an embodiment, reference resolution may be employed to share data across different MST instances (e.g., in a MMST deployment) to determine potential reference candidates for a disk (e.g., snapshot) and select one of the candidates as a best reference. The potential reference candidates may be provided by a client arranged in a priority order. An MST instance 1000 selects the best reference candidate that is available at an MST site (e.g., availability zone) based on the priority order specified by the client and holds (renders) a reference on that snapshot by establishing (creating) a parent-child relationship. As used herein, an availability zone (AZ) is a logical boundary for a group of managed computer nodes deployed in one or more geographical locations or sites. Illustratively, the parent-child relationship is established using a child vector-based approach wherein a parent snapshot maintains the list of one or more child snapshots (e.g., instead of a reference count value) that ensures GC of a child snapshot does not remove the reference of another child snapshot. The parent-child relationship may be established by updating (i) the parent reference field 1120 in a child snapshot (e.g., disk) configuration to keep track of its parent snapshot and (ii) the child vector (child_vec) field 1110 in a parent snapshot (e.g., disk) configuration to keep track of its child snapshot. FIG. 12 is a block diagram illustrating updates of the parent-child information maintained by the snapshot in a MMST deployment 1200. Here, the child vector field 1110 of a parent snapshot V1S1 is updated to reflect <V1S2 and V1S3> child snapshots. Notably, a list of child snapshots recorded in the child vector field 1110 may be advantageously used (employed) to identify child snapshots that are dependent on (referenced to) a parent snapshot across MST instances, e.g., MST1 and MST2.

In an embodiment, deletion of a parent snapshot having more than one referenced child snapshot transitions the parent snapshot into a state wherein garbage collection (GC) of the parent snapshot is prevented until there is less than or equal to one referenced child snapshot. Upon deletion of a child snapshot, the parent disk configuration is updated to remove the child entry from its ‘child_vec’ field 1110 and the child disk configuration is deleted in the regular GC workflow. Notably etags provided by the storage object (‘entity tag’ as a hash of the object) may be used to disambiguate object access so that if two or more MST instances issue update requests to the same disk configuration, then one of the requests fails due to an etag mismatch. The failed request may be retried after reading the disk configuration from the object store with a latest etag.

### Garbage Collection

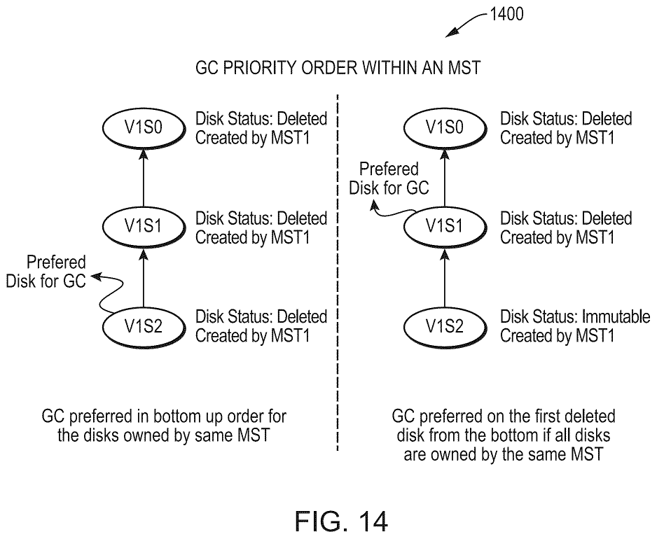

When multiple MST instances share the same set of buckets, the MST instances may have common references among them. FIG. 13 is a block diagram illustrating a MMST deployment 1300 wherein two MST instances (MST1 and MST2) create snapshots of recovery points (RPs), e.g., per client requests. Each snapshot has a stamped MST ID (UUID) indicating the MST owner instance of the snapshot. Lifecycle management (e.g., GC) of the snapshot is performed only (exclusively) by the MST owner instance. If the MST owner instance is destroyed, a new MST instance with the same UUID is created or ownership of the snapshot is transferred to another MST instance. An MST instance that runs for a long period of time may have disk configurations for other disks (snapshots) that it does not own. According to the technique, GC job logic 1020 of an MST instance 1000 is configured to consider the deleted snapshots for which the MST instance has ownership.

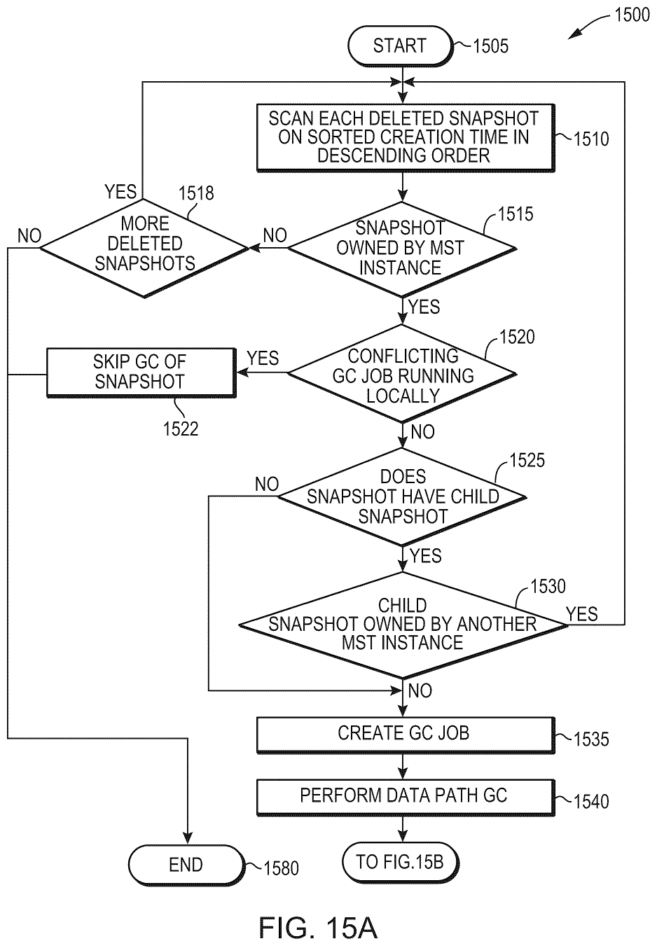

In an embodiment, the GC job logic 1020 is generally configured to perform GC in a bottom-up manner because of the likelihood of cleaning up more garbage. If a GC job runs for a current snapshot, then another GC job cannot start on its parent snapshot and child snapshots because their GC will conflict with the current snapshot. FIG. 14 is a block diagram illustrating GC (e.g., via GC job logic 1020) on a snapshot chain (hierarchy) within an MST instance 1000 of a MMST deployment 1400. On the left side of the diagram, an MST instance (MST1) has three deleted snapshots that it owns. In such a case, the GC job logic 1020 selects the bottom most snapshot for the garbage collection. On the right side of the diagram, the bottom most snapshot is not marked for deletion and, therefore, the adjacent (next) snapshot is selected for the garbage collection.

In an embodiment, if the snapshots in the hierarchy are owned by multiple MST instances, then GC on a snapshot may start only if the snapshot does not have a child snapshot owned by another MST instance. This aspect of the technique focuses on the need to compare (and delete) B+ tree data and index objects/sets as well as a cross-over point rule between MST instance snapshot ownership as set forth in the GC procedural extension. That is, an adjacency rule prevents GC on two adjacent snapshots of a current snapshot undergoing GC because the GC procedure requires analysis of parent and child snapshots of the current snapshot, whereas the cross-over point rule prevents GC of a parent snapshot owned by an MST instance until GC has completed on a child snapshot owned by a different MST instance (even if the child snapshot has expired).

To prevent a race condition among different MSTs attempting to run GC operations in parallel on conflicting snapshots, the technique serializes GC of the two adjacent snapshots according to the adjacency and cross-over point rules. Moreover, the different MST instances may release dependency references from their child snapshots to the parent snapshot (even if the child has expired) before the parent snapshot may be garbage collected. Upon completion of the child snapshot GC, the child vector of the parent snapshot is updated to remove the reference to the child snapshot owned by another MST instance. Note that a MMST deployment where adjacent snapshots are created by multiple MST instances is rare because subsequent snapshots in the same hierarchy/chain typically hold references on snapshots owned by the same MST instance.

In an embodiment, there are various types of garbage collection in the MST including forward path garbage collection, data path garbage collection, and un-finalized garbage collection. Forward path garbage collection (GC) is configured to clean-up transient metadata (e.g., segment table, logs/journals, including object WAL-write ahead log) created during write operations (write path) typically when finalizing a disk (snapshot) and/or when un-finalized snapshot is marked for deletion. Data GC involves data objects (i.e., shared objects) including objects created by ancestor snapshots owned by their descendant snapshots because ancestor snapshots are deleted. Such objects need to be garbage collected when GC runs on the descendant snapshots, which may be owned by different MST instances. Un-finalized GC requires deletion of RP snapshots and marking their status Deleted in the snapshot (disk) configuration. Un-finalized GC is configured to clean-up data objects, index objects, segment table, object WAL, and snapshot (disk) configuration.

### GC Procedural Extension

The technique described herein extends the GC procedure (e.g., algorithm) that determines which data objects of data storage units (snapshots) exclusively own data blocks of expired snapshots by, e.g., scanning indexes of immediate parent and child snapshots and, as a result, whether the snapshot is a candidate for GC. In accordance with the GC procedural extension, an MST instance of a MMST deployment can GC only those snapshots that it creates and owns. An MST owner instance is responsible for managing the lifecycles of those snapshots. An MST instance may start GC on a snapshot only if (i) there is no conflicting operation being performed on the snapshot, and (ii) there is no child snapshot owned by another MST instance. The GC procedural extension also determines which data objects can be reclaimed when a snapshot expires.

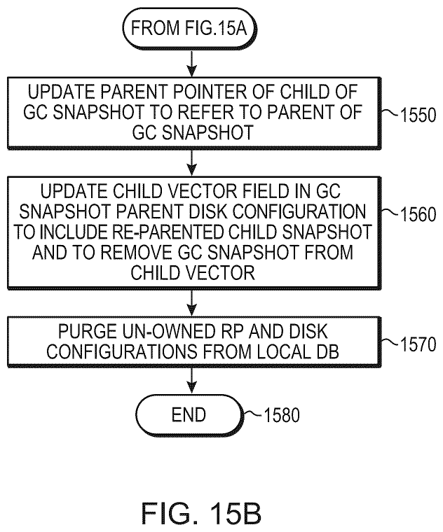

FIGS. 15A and 15B are flow charts of an extension to the GC procedure for garbage collecting data in the MMST deployment. In an embodiment, the following steps of the GC procedural extension 1500 are illustratively performed by frontend data service 1010 (e.g., similar to frontend data service 710) of the MST instance 1000, although it is known to persons of skill in the art that the procedure may be performed by other services. In an embodiment, the GC procedural extension 1500 starts at step 1505 and proceeds to the following steps:
1. At step 1510, scan each deleted disk (snapshot) of a RP based on sorted creation time in descending order to facilitate processing of a bottom-up snapshot first. Hence, a descendent snapshot is granted priority over an ancestor snapshot due to the sort.
2. For each scanned snapshot
   a. At step 1515, determine whether the scanned snapshot is owned by the current MST. If the scanned snapshot is owned by the current MST, proceed to step 1520. If the scanned snapshot is not owned by the current MST, determine whether there are more deleted snapshots to scan (step 1518). If so, return to step 1510 and, if not, end procedural extension (proceed to step 1580)
   b. At step 1520, determine whether there is a conflicting GC job running locally. If there is a conflicting GC job running locally (yes), then skip GC of the snapshot (step 1522) and end the procedural extension (proceed to step 1580).
   c. At step 1525, determine whether the scanned snapshot has a child snapshot. If not, proceed to step 1535; otherwise
   d. At step 1530, examine the ‘child_vec’ pointers of the scanned snapshot to determine whether there is a child snapshot owned by some other MST instance. If so, return to step 1510 and, if not, proceed to step 1535).
At step 1535, create a GC Job.
For each GC job
   a. At step 1540, perform data GC.
   b. At step 1550, update parent pointer of the child for the garbage collected (GC) snapshot to refer to the parent of the GC snapshot.
   c. At step 1560, update the child vector field in the GC snapshot's parent disk configuration to include the child snapshot being re-parented and to remove GC snapshot from child vector.
   d. At step 1570, purge any un-owned RP and disk configurations from the local DB periodically. The GC procedural extension 1500 then ends at step 1580.

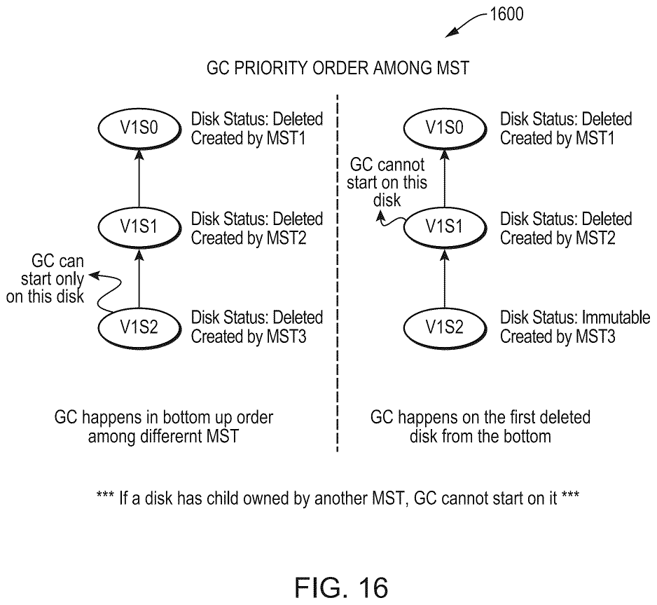

FIG. 16 is a block diagram illustrating exemplary MMST deployments 1600 for GC on a snapshot chain (hierarchy) among MST instances. In a first deployment shown on the left side, three deleted snapshots are owned by MST1, MST2 and MST3, respectively. Only the bottom most snapshot, i.e., V1S2, is applicable for GC because the snapshot does not have any child snapshot owned by another MST instance. In a second deployment shown on the right side of the diagram, GC on the deleted snapshot V1S1 does not commence (start) because the snapshot has a child snapshot that is owned by MST2. Such a restriction (constraint) facilitates synchronization of GC operations among the snapshots and ensures that GC does not run on conflicting snapshots in the hierarchy.

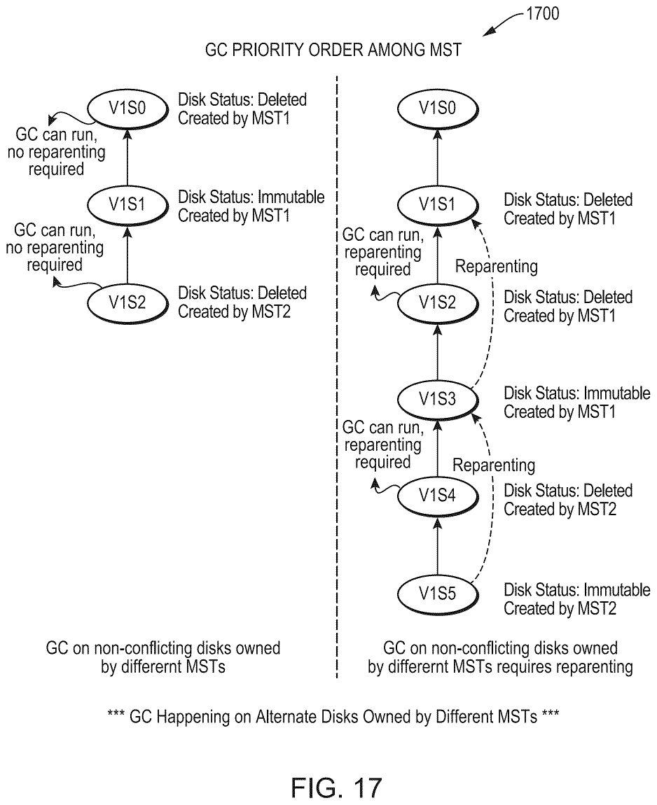

FIG. 17 is a block diagram illustrating other exemplary MMST deployments 1700 for GC on a snapshot chain (hierarchy) among MST instances. Here, two additional MMST deployments are shown wherein GC may run on alternate disks without GC operations conflicting with each other. The left side of the diagram illustrates a MMST deployment where re-parenting (i.e., changing of a dependency order) of snapshots is not required, whereas the right side of the diagram illustrates a MMST deployment where re-parenting is required for the child of the snapshot being GC′d.

Advantageously, the technique described herein improves storage efficiency of an object store by allowing performance of garbage collection operations on the snapshots in parallel among the multiple MST instances without communication among the instances and in a manner that ensures correctness of the operations. The technique enables efficient determination of the exclusively owned data objects through inspection of index data structures associated with an expiring snapshot, its immediate predecessor (parent) snapshot, and its immediate successor (child) snapshot.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the objective of the appended claims to cover all such variations and modifications as come within the true spirit and scope of the embodiments herein.

1. A method comprising:
generating one or more snapshots of a virtual disk (vdisk) at one or more compute nodes of a cluster;
storing the snapshots in an object store managed by a plurality of multi-cloud-based snapshot technology (MST) services, wherein the MST services are configured to construct index data structures that reference snapshot data and metadata within data objects of the object store, wherein each MST service is associated with an MST identifier (ID);
at a first MST service instance,
inspecting a child vector of an expiring snapshot to determine whether an immediate successor child snapshot is owned by a second MST service instance different than the first MST service instance, wherein the child vector includes an MST owner ID and a child snapshot ID that references the child snapshot of the expiring snapshot; and
in response to determining that the child snapshot is owned by the second MST service instance, garbage collecting the expiring snapshot in parallel with garbage collection of the child snapshot by the second MST service instance, wherein the garbage collection includes scanning an index data structure of the expiring snapshot from a root node to leaf nodes to obtain a set of object IDs associated with the data objects referenced by the leaf nodes of the index data structure and garbage collecting the data objects referenced by remaining object IDs that are determined to have no reference in the child snapshot, and wherein the garbage collection occurs in parallel among the MST service instances to ensure correctness of the garbage collection without communication among the service instances.

2. The method of claim 1, wherein a priority order for performing garbage collection for the MST service instances occurs from the lowest ordered snapshot within a hierarchy of the expiring snapshot.

3. The method of claim 1 wherein garbage collecting further comprises:
marking the garbage collected expiring snapshot as un-finalized until metadata associated with the expiring snapshot is garbage collected.

4. The method of claim 1 further comprising:
re-parenting the child snapshot of the expiring snapshot as another child snapshot of an immediate predecessor parent snapshot of the expiring snapshot.

5. The method of claim 1, further comprising:
at the first MST service instance, garbage collecting the expiring snapshot.

6. The method of claim 1, further comprising:
at the first MST service instance, purging unowned recovery points including the snapshots.

7. The method of claim 1, further comprising:
at the first MST service instance,
finalizing deletion of the expiring snapshot.

8. The method of claim 1, further comprising:
at the first MST service instance,
updating the child vector of an immediate parent snapshot of the expiring snapshot to no longer reference the expiring snapshot.

9. The method of claim 1, further comprising:
deferring garbage collection of the expiring snapshot until the child 2 snapshot is garbage collected.

10. A non-transitory computer readable medium including program instructions for execution on a processor, the program instructions configured to:
generate one or more snapshots of a virtual disk (vdisk) at one or more compute nodes of a cluster;
store the snapshots in an object store managed by a plurality of multi-cloud-based snapshot technology (MST) services, wherein the MST services are configured to construct index data structures that reference snapshot data and metadata within data objects of the object store, wherein each MST service is associated with an MST identifier (ID);
at a first MST service instance
inspecting a child vector of an expiring snapshot to determine whether an immediate successor child snapshot is owned by a second MST service instance different than the first MST service instance, wherein the child vector includes an MST owner ID and a child snapshot ID that references the child snapshot of the expiring snapshot;
in response to determining that the child snapshot is owned by the second MST service instance, garbage collecting the expiring snapshot in parallel with garbage collection of the child snapshot, wherein the garbage collection includes scanning an index data structure of the expiring snapshot from a root node to leaf nodes to obtain a set of object IDs associated with the data objects referenced by the leaf nodes of the index data structure and garbage collecting the data objects referenced by remaining object IDs that are determined to have no reference in the child snapshot, and wherein the garbage collection occurs in parallel among the MST service instances to ensure correctness of the garbage collection without communication among the service instances.

11. The non-transitory computer readable medium of claim 10, wherein a priority order for performing garbage collection for the MST service instances occurs from the lowest ordered snapshot within a hierarchy of the expiring snapshot.

12. The non-transitory computer readable medium of claim 10, wherein the program instructions are further configured to:
mark the garbage collected expiring snapshot as un-finalized until metadata associated with the expiring snapshot is garbage collected.

13. The non-transitory computer readable medium of claim 10, wherein the program instructions are further configured to:
re-parent the child snapshot of the expiring snapshot as another child snapshot of an immediate predecessor parent snapshot of the expiring snapshot.

14. The non-transitory computer readable medium of claim 10, wherein the program instructions are further configured to:
at the first MST service instance, garbage collect the expiring snapshot.

15. The non-transitory computer readable medium of claim 10, wherein the program instructions are further configured to:
at the first MST service instance, purge unowned recovery points including the snapshots.

16. The non-transitory computer readable medium of claim 10, wherein the program instructions are further configured to:
at the first MST service instance,
finalize deletion of the expiring snapshot.

17. The non-transitory computer readable medium of claim 10, wherein the program instructions are further configured to:
at the first MST service instance,
update the child vector of an immediate parent snapshot to no longer reference the expiring snapshot.

18. The non-transitory computer readable medium of claim 10, wherein the program instructions are further configured to:
defer garbage collection of the expiring snapshot until the child snapshot is garbage collected.

19. An apparatus comprising:
a frontend data service connected via a network to an archival storage system, the frontend data service executing instructions on a processor configured to:
generate one or more snapshots of a virtual disk (vdisk) at one or more 4 compute nodes of a cluster;
store the snapshots in an object store managed by a plurality of multi-cloud-based snapshot technology (MST) services, wherein the MST services are configured to construct index data structures that reference snapshot data and metadata within data objects of the object store, wherein each MST service is associated with an MST identifier (ID);
at a first MST service instance
inspecting a child vector of an expiring snapshot to determine whether an immediate successor child snapshot is owned by a second MST service instance different than the first MST service instance, wherein the child vector includes an MST owner ID and a child snapshot ID that references the child snapshot of the expiring snapshot;
in response to determining that the child snapshot is owned by the second MST service instance, garbage collecting the expiring snapshot in parallel with garbage collection of the child snapshot by the second MST service instance, wherein the garbage collection includes scanning an index data structure of the expiring snapshot from a root node to leaf nodes to obtain a set of object IDs associated with the data objects referenced by the leaf nodes of the index data structure and garbage collecting the data objects referenced by remaining object IDs that are determined to have no reference in the child snapshot, and wherein the garbage collection occurs in parallel among the MST service instances to ensure correctness of the garbage collection without communication among the service instances.

20. The apparatus of claim 19, wherein a priority order for performing garbage collection for the MST service instances occurs from the lowest ordered snapshot within a hierarchy of the expiring snapshot.

21. The apparatus of claim 19, wherein the instructions are further configured to:
mark the garbage collected expiring snapshot as un-finalized until metadata associated with the expiring snapshot is garbage collected.

22. The apparatus of claim 19, wherein the instructions are further configured:
re-parent the child snapshot of the expiring snapshot as another child snapshot of an immediate predecessor parent snapshot of the expiring snapshot.

23. The apparatus of claim 19, wherein the instructions are further configured to:
at the first MST service instance, garbage collect the expiring snapshot.

24. The apparatus of claim 19, wherein the instructions are further configured to:
at the first MST service instance, purge unowned recovery points including the snapshots.

25. The apparatus of claim 19, wherein the instructions are further configured to:
at the first MST service instance, finalize deletion of the expiring snapshot.

26. The apparatus of claim 19, wherein the instructions are further configured to:
at the first MST service instance,
update the child vector of an immediate parent snapshot to no longer reference the expiring snapshot.

27. The apparatus of claim 19, wherein the instructions are further configured to:
defer garbage collection of the expiring snapshot until the child snapshot is garbage collected.

28. A method comprising:
performing lifecycle management of one or more snapshots stored on an object store and served by a long-term storage service executing on one or more computer nodes, wherein the lifecycle management includes garbage collection of an expired snapshot owned by the long-term storage service;
maintaining snapshot configuration information on the object store relating to a child snapshot of the expired snapshot, the snapshot configuration information including a long-term storage service owner identifier (ID) of the child snapshot;
inspecting the owner ID to determine whether the child snapshot is owned by a different long-term storage service; and
in response to determining that the child snapshot is owned by the different long-term storage service, garbage collecting the expiring snapshot by the long-term storage service in parallel with garbage collection of the child snapshot by the different long-term storage service, and wherein the garbage collection occurs in parallel among the long-term storage services to ensure correctness of the garbage collection without communication among the services.
